(19) United States
(12) Patent Application Publication
(10) Pub. No.: US 2023/0286596 A1
(43) Pub. Date: Sep. 14, 2023

(54) VEHICLE COMPONENT AND METHOD

(71) Applicant: Transportation IP Holdings, LLC, Norwalk, CT (US)

(72) Inventors: Stephen Hankinson, Mars, PA (US); Devin Krahl, Independence, MO (US); Cody Johnson, Independence, MO (US); Michael Matthews, Independence, MO (US); Brian Early, Independence, MO (US)

(21) Appl. No.: 18/172,848

(22) Filed: Feb. 22, 2023

Related U.S. Application Data
(60) Provisional application No. 63/269,321, filed on Mar. 14, 2022.

(51) Int. Cl. B62D 29/04

(52) U.S. Cl. CPC B62D 29/04; B29C 70/52

(57) ABSTRACT

A method and system are provided for a fiberglass component for vehicles. A vehicle component has a pultruded fiberglass-reinforced polymer body made of a glass fabric and a cured polymer resin. The body is integrally formed by a pultrusion manufacturing process as a vehicle hatch cover and is shaped to seal an opening of the vehicle.

### CROSS REFERENCE TO RELATED APPLICATIONS

The present application claims priority to U.S. Provisional Application No. 63/269,321, entitled “VEHICLE COMPONENT AND METHOD”, and filed on Mar. 14, 2022. The entire contents of the above-listed application are hereby incorporated by reference for all purposes.

### BACKGROUND

### Technical Field

Embodiments of the subject matter disclosed herein relate to vehicle components. Other embodiments relate to fiberglass components for vehicles.

### Discussion of Art

A vehicle may include fiberglass components, such as a hatch cover. The hatch cover provides access to interior spaces of the vehicle. Hatch covers may be manufactured via molding or fabrication. Some fiberglass hatch covers may be molded by hand.

However, fiberglass hatch covers molded by hand may have undesired variations in thickness, material uniformity, etc. as a result of the hand-laying process. Such variations may result in unexpected performance characteristics of the hatch covers as well as large manufacturing times and/or costs. Additionally, it may be difficult to sufficiently reinforce such hatch covers, as the molding process may use particular material formulations that have less than a desired strength and/or durability.

For example, FIG. 8 shows an enlarged view of a portion 800 of a hatch cover that is formed by a hand laying process. In the example shown, the portion includes a mixture of a glass fiber material 802 and a resin material 804. The resin material and glass fiber material are hand laid (e.g., resin material may be poured into a mold and the glass fiber material may be embedded into the poured resin material by a technician), and as a result, the portion includes several regions that do not include any of the glass fiber material. For example, the portion may include a region 806 and a region 808 each with a different amount of fiber reinforcement relative to the main body. In this arrangement, the amount of glass (e.g., glass fiber material) by weight of the hatch cover may be less than 50% or even absent entirely. In particular, the weight of the total amount of glass in the portions of the hatch cover including the resin material is less than a weight of the total amount of resin material.

It may be desirable to provide a vehicle component and method of manufacturing that are different from existing components and manufacturing methods.

### BRIEF DESCRIPTION

In one embodiment, a component for a vehicle is provided. The component may include a fiberglass-reinforced polymer body comprising a glass fabric and a cured polymer resin, and the body is integrally formed as a hatch cover that is shaped to seal an opening of the vehicle.

In one embodiment, a method is provided that includes providing a glass fiber material and a resin material to a die coupled to a pultrusion device. The method includes pultruding a mixture of the glass fiber material and the resin material through the die. The glass fiber may be oriented relative to a direction of the pultrusion. An uncured body may be formed as a single, unitary piece having more than 50% glass content by weight relative to the resin. The method includes curing the uncured body to form a vehicle hatch cover.

In one embodiment, a vehicle component is provided that includes a pultruded fiberglass-reinforced polymer body that can form at least a portion of a hatch cover and that includes a curved central portion joined to a first side extension and an opposing, second side extension, and the fiberglass-reinforced polymer has a glass content that is in a range of from greater than 50% glass by weight to about 90% glass by weight.

### BRIEF DESCRIPTION OF THE FIGURES

FIG. 1 shows a schematic diagram of a rail vehicle including a hatch cover, according to an embodiment.

FIG. 2 shows a top perspective view of a hatch cover for a rail vehicle, according to an embodiment.

FIG. 3 shows a bottom perspective view of the hatch cover of FIG. 2.

FIG. 4 shows a sectional side perspective view of the hatch cover of FIGS. 2-3.

FIG. 5 shows another sectional side perspective view of the hatch cover of FIGS. 2-4.

FIG. 6 shows an enlarged partial view of an end of the hatch cover of FIGS. 2-5.

FIG. 7 shows a front view of a body of the hatch cover of FIGS. 2-6.

FIG. 8 shows an enlarged view of a portion of a conventional hatch cover for a rail vehicle.

FIG. 9 shows an enlarged view of a portion of a hatch cover for a rail vehicle, according to an embodiment.

FIG. 10 shows a flow chart illustrating a method for forming a fiberglass component for a rail vehicle, according to an embodiment.

FIG. 11 shows a graph illustrating a prophetic example of an average strength versus glass content relationship of a hatch cover for a rail vehicle.

### DETAILED DESCRIPTION

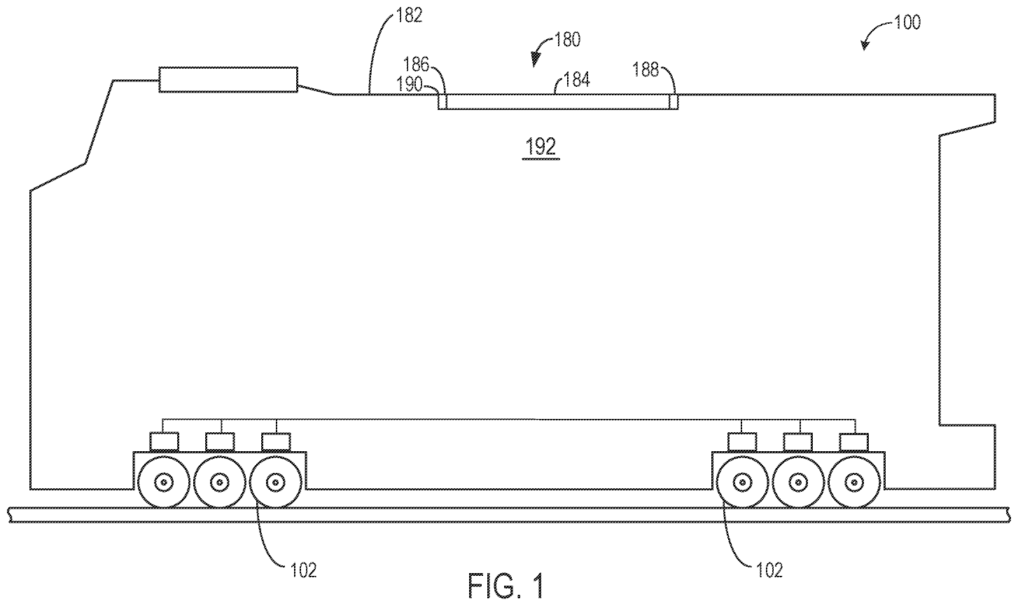

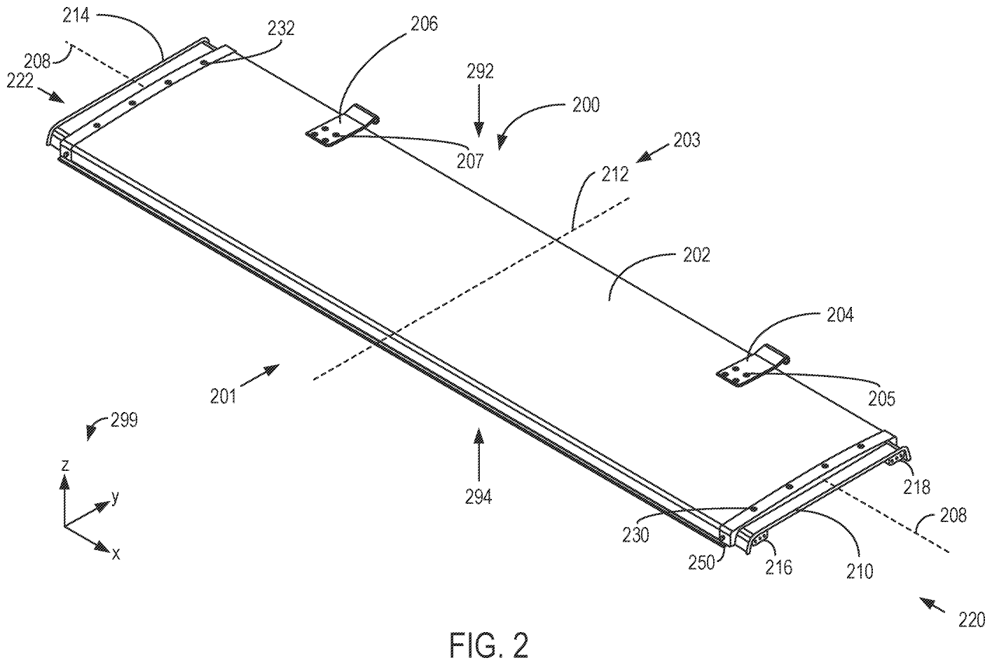

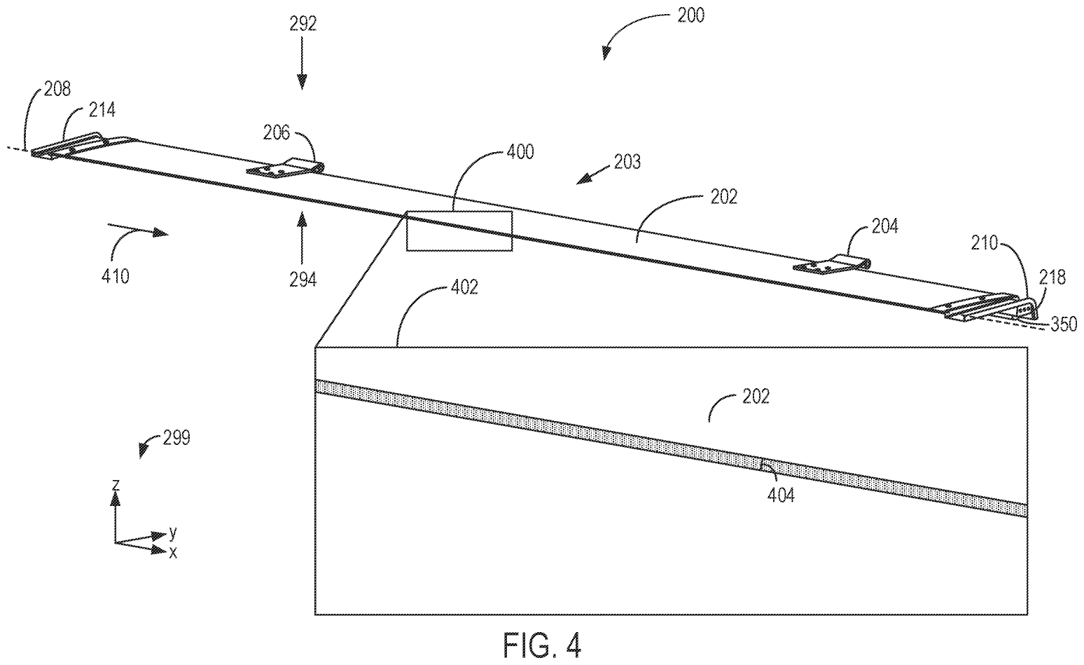

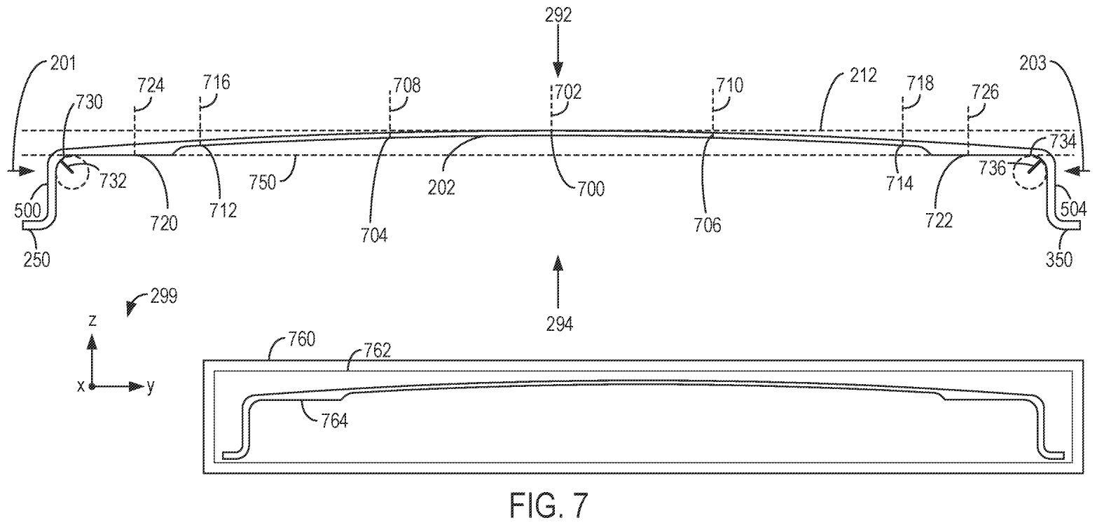

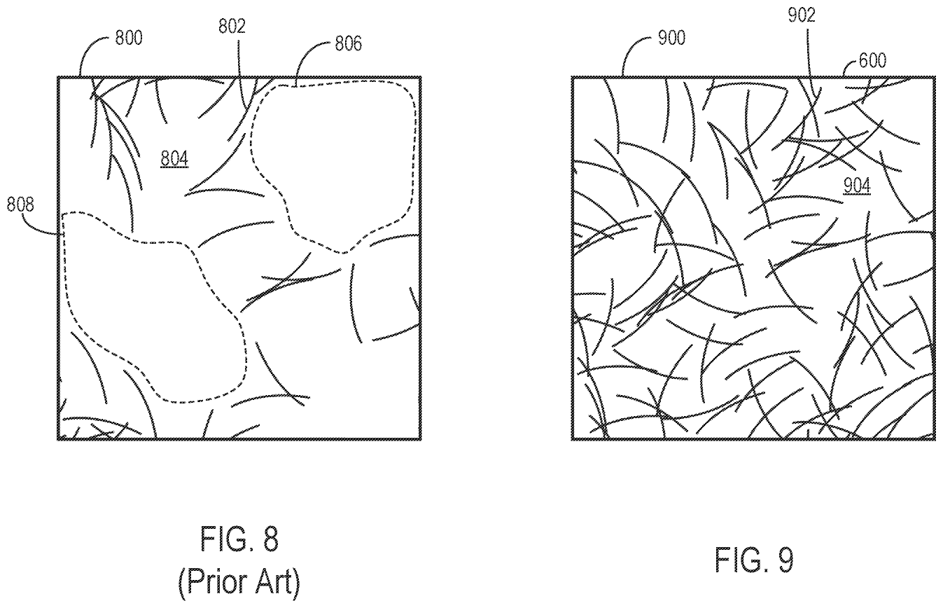

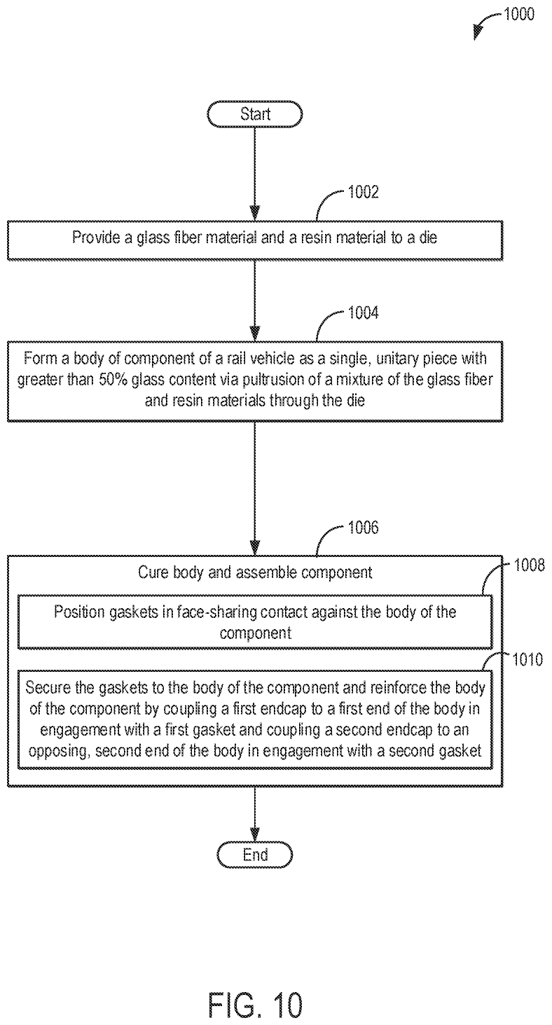

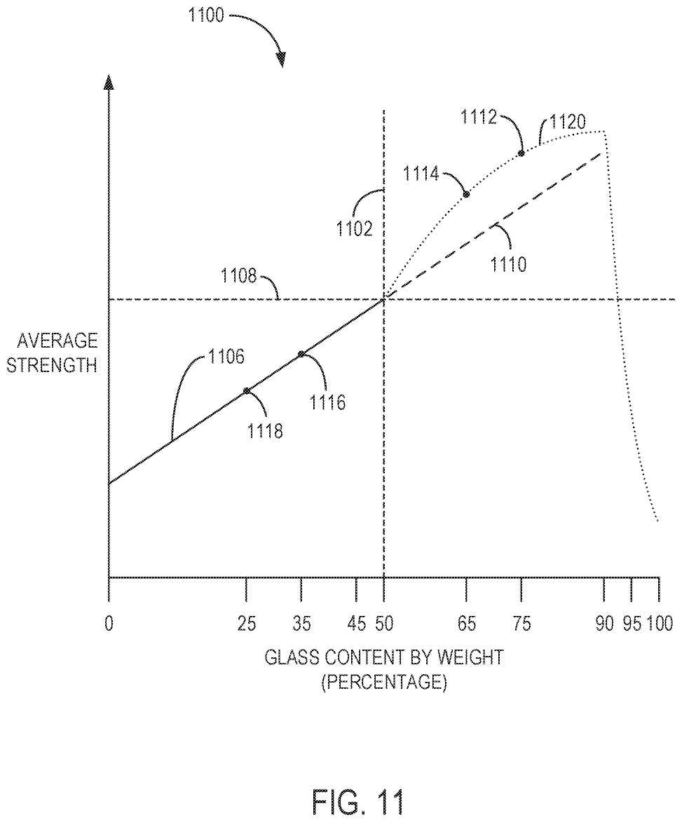

The following description relates to a system and method for a vehicle component. In one embodiment, the vehicle component is a fiberglass hatch for a rail vehicle. In various embodiments, and with reference to FIG. 1, a rail vehicle includes a hatch cover that can provide access to an interior of the rail vehicle. The hatch cover, such as the hatch cover shown by FIGS. 2-7, is formed from a glass fiber material. Conventional fiberglass hatch covers have less than 50% glass content by weight, as shown by FIG. 8. However, the fiberglass hatch cover of the disclosure has greater than 50% glass content by weight, as shown by FIG. 9. The hatch cover may be formed by a pultrusion manufacturing process, as illustrated by the flowchart of FIG. 10. As a result, in embodiments, the hatch cover may have a relatively consistent thickness in along the longitudinal cross-section, as shown by FIG. 4. However, the thickness may be different at different locations along the lateral cross-section, as shown by FIG. 7. In some embodiments, the average strength of the hatch cover may increase in a non-linear fashion for percentages of glass content by weight above 50%, as shown by FIG. 11, such that configuring the glass content by weight to be greater than 50% results in increased gains to strength and durability relative to the net weight of the hatch cover. The thickness at various locations along the lateral cross-section may be selected and accurately controlled via the pultrusion process to provide desired strength characteristics of the hatch cover while reducing an overall weight of the hatch cover and/or material usage in manufacturing of the hatch cover. As a result, an ease of installation of the hatch cover may be increased and/or a cost of manufacturing of the hatch cover may be decreased.

Referring again to FIG. 1, a block diagram of an embodiment of a vehicle system 100 is shown. The vehicle system in the illustrated embodiment is a rail vehicle (for example, the rail vehicle may be a locomotive, or a hopper car, box car, tank car, etc.) which may engage with a rail via wheels 102. The vehicle system includes a hatch cover 180 disposed on a top surface 182 of the vehicle system. The hatch cover includes a body 184. The cover can selectively close, and when in a closed position it can seal an opening 190. A sealing system adjacent to a peripheral edge may facilitate the sealing. The hatch cover includes a first endcap 186 coupled to a first end of the hatch body and a second endcap 188 coupled to a second end of the hatch body. The hatch cover may include one or more gaskets that can seal the interface between the hatch cover and the surfaces of the vehicle (e.g., the perimeter of the opening formed in the top surface). The opening provides access to and from an interior volume 192 of the vehicle. The hatch cover, in switching to a closed position, closes the hatch. In one embodiment, the hatch cover is coupled to a hinge, and hingedly moves between an open position and the closed position. Suitable shapes for the hatch cover and corresponding hatch may include circular, oval, square and rectangle. Other shapes may be used, but predominantly the hatch cover shape, size, composition, and design depend on the hatch needed to be covered, and to some extent the purpose of the interior volume (such as what is intended to be stored therein).

In the example shown, the interior volume is a vehicle compartment. For example, the interior volume may be adapted to hold the engine of the vehicle system. In other embodiments, the hatch cover may be disposed at a different section of the vehicle, or on a different type of vehicle. If the hatch cover is included on a rail car the interior volume may be storage for freight, or a cabin for passengers, and the like. Suitable freight may include cargo, liquids, bulk solids, other vehicle components, and the like. In one embodiment, the hatch (and hatch cover) are primarily an egress, such as an emergency exit.

The hatch cover body may be reinforced material. Suitable reinforcing materials may include one or more of fibers, powders, platelets, whiskers, spheres (hollow or solid), and the like. A suitable forming process for the body may include pultrusion. In one embodiment, the body may be formed as a single, unitary piece (e.g., monolithic unit of fiberglass material without fasteners or other parts used to form the body) by pultruding a mixture of the fibers and resin through a die or a roller system. Suitable fibers may include individual strands, chopped strand mat, woven fiber fabric, knit fiber fabric, unidirectional fiber fabric, and the like. Suitable fiber materials may include glass (e.g., silica glass and borosilicate glass), carbon, aramid, metal, ceramic, and combinations thereof.

The glass type may be selected based at least in part on application specific parameters. Suitable glass types may include A, C, D, E, M, S, ECR, R, Te, and the like. Glass types A, C, D, E, M, S, ECR, R, and Te may be referred to herein as A-glass, C-glass, D-glass, E-glass, M-glass, S-glass, ECR-glass, R-glass, and Te-glass, respectively. Factors that may go into the glass type selection may correspond to the glass types, for example, A for alkali resistance, C for chemical resistance, D for a low dielectric constant, E for low electrical conductivity, M for high tensile modulus, S for high tensile strength, ECR for long term acid resistance but short term alkali resistance, and R & Te for high tensile strength at high temperatures. When selecting the glass, plural glass types may be selected to realize the benefit of each glass type. Also, the glass types may be layered. That is, a C-glass may be employed in a layer that forms an inward facing surface of a hatch that may contact corrosive cargo, while M-glass may be employed in a layer that forms an outward facing surface of the hatch that may be potentially subject to impact. Configurations including multiple layers may be referred to herein as multi-layered. For example, a hatch cover body formed from multiple glass layers, with the strands of glass of one layer having a different orientation relative to strands of glass of another layer, may be described herein as a hatch cover body with directionally oriented strands in determined directions forming a multilayer woven configuration.

The fibers may be coated in some embodiments, and uncoated in other embodiments. In one embodiment, the glass fibers have a sizing material. Suitable sizing materials may be formed from silane. A suitable sizing material may have one or more functional groups. Suitable functional groups may include epoxy, cyano, vinyl, amine/amino, acryl (e.g., methacryloxy), esters (e.g., vinyl esters), and the like.

In various embodiments, the non-reinforcement balance of the weight may be resin, different fibers, or other additive materials. Resins may be thermoset or thermoplastic. In one embodiment, suitable resins may include esters, epoxies, urethanes, acrylates and the like. Suitable esters may include polyester and vinyl ester. Additives may be used to modify the properties of the resin. Flow enhancers, hardeners, colorants, static preventers, impact resistors, flame retardants, UV resistors, plasticizers, hydrophobic agents, and the like may be added based on desired end use parameters.

In one embodiment, the hatch body of the hatch cover includes greater than 50% glass content by weight. That is, the hatch body includes more than 50% of the weight of the hatch body as a result of the weight of the glass fibers. In one embodiment, the amount of fiber (glass or otherwise) may be in a range of greater than about 50% by weight. In other embodiments, the amount of fiber may be in a range that is from about 51% to about 60%, from about 61% to about 70%, from about 71% to about 80%, from about 81% to about 90%, and greater than about 90% by weight of the fiber relative to the resin. In some examples, the percentage of glass content by weight may vary within a range of +/−3% of the stated value. As one example, a configuration including “about 90%” or “approximately 90%” glass content by weight may refer to a range of 87%-93% glass content by weight. As another example, a configuration including “about 80%” or “approximately 80%” glass content by weight may refer to a range of 77%-83% glass content by weight. As used herein, the terms “approximately” and “about” mean plus or minus three percent of the range unless otherwise specified.

While it is relatively easier to form composites having relatively lower volume/weight of fiber compared to higher, the properties of the composite may not change in a predictable manner, nor may some of the characteristics meet determined end use requirements. That is, simply adding more fiber may not result in a hatch cover body suitable for every particular use. Various factors, particularly the mechanical properties of the body, may be considered in selecting the formulation and the formulation selection may be considered in selecting the production process method. A high-fiber content body may not be achievable using a hand layup production method, for example. A particular fiber content may be useful to achieve a thickness of material that at higher or lower fiber content levels may be unsuitable for the application (e.g., too brittle or too flexible).

Because the hatch body of the hatch cover may be formed from the fiberglass material via pultrusion, the hatch cover may have increased performance relative to conventional hatch covers that are not formed via pultrusion of fiberglass material. For a hatch body that has greater than 50% glass content by weight relative to a hatch body that has less than 50% by weight, the increased glass content may result in relatively increased strength, increased heat resistance, decreased electrical conductivity, and increased rigidity. Increasing the glass content (by weight) over 50% may create a significant increase in the resistance of the hatch cover to deformation (e.g., bending or denting).

The glass fibers within the hatch body may be more evenly distributed by pultrusion relative to conventional hatch covers formed by a hand laying process. The more even distribution of the glass fibers may increase the load bearing capacity of the hatch cover along the entirety of the hatch body. Further, forming the hatch body from the fiberglass material via pultrusion may provide a manufacturer with an increased level of control and precision over the thickness of the hatch body such that portions of the hatch body that may experience increased loads may be formed with an increased thickness and portions of the hatch body that may experience decreased loads may be formed with a relatively decreased thickness (or a relatively lower fiber content). As a result, the hatch body of the hatch cover may provide the desired strength and load bearing characteristics with a reduced amount of material. This may reduce assembly complexity, quantity and types of materials used, manufacturing costs, and/or a weight of the hatch cover. As one example, the glass content of the body of the hatch cover may sufficiently reinforce the body such that sufficient strength of the body may be provided without other reinforcing materials (e.g., mesh, steel, etc.). Additionally, the thickness at various portions of the hatch body may be formed more consistently with a desired thickness, reducing a likelihood of undesired performance characteristics relative to conventional hatch covers which may include abnormalities as a result of gravity and other forces acting on the material during the hand laying process.

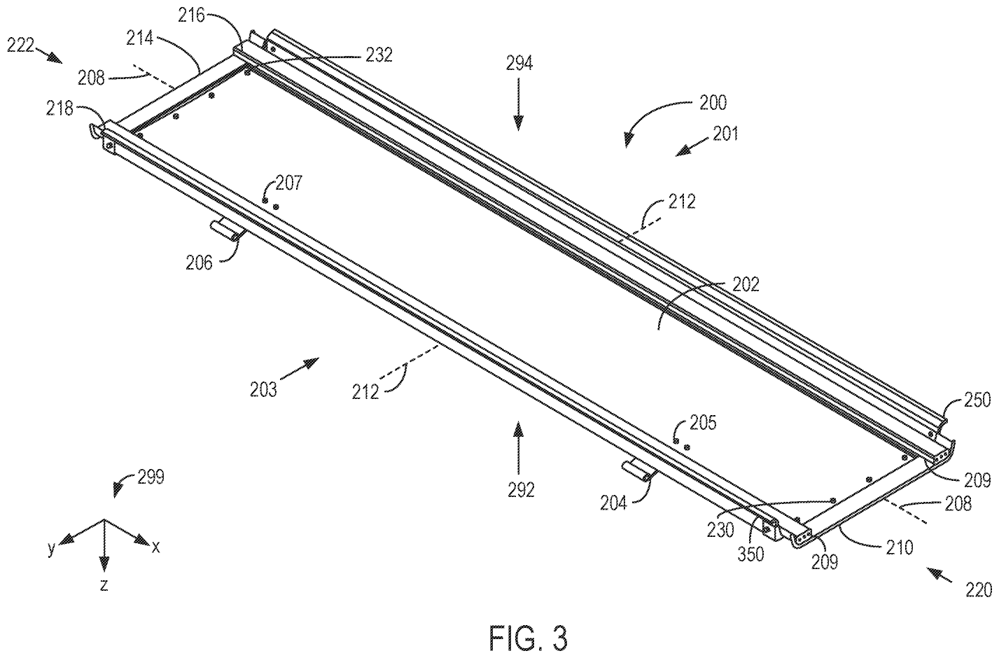

A top perspective view of the hatch cover 200 is shown in FIG. 2 and FIG. 3 shows a bottom perspective view of the hatch cover. The hatch cover may have some features that are similar to, or the same as, the hatch cover shown by FIG. 1 and described above. The hatch cover may be coupled to a hatch on a vehicle. In the illustrated embodiment, a body 202 of the hatch cover may formed from a fiberglass material via pultrusion, similar to the example described above with reference to FIG. 1. The illustrated body is a glass-fiber reinforced polyester pultruded material. The body is formed as a single, unitary piece (e.g., a continuous, single unit) having a mixture of glass fiber and resin that has been pultruded through a die of a pultrusion device, and may be referred to herein as a pultruded fiberglass-reinforced polymer body. The body may be uncured during the pultrusion process and may be cured following the pultrusion process (e.g., the body may be a single, uncured unitary piece formed via pultrusion and may be cured via a separate process such as UV exposure, heat exposure, etc.). The pultrusion process may provide the body with a controlled thickness and profile, where, for each location along the body in a lateral direction (e.g., the direction of lateral axis 212), the respective thickness at the location is relatively constant along an entire length of the body in a longitudinal direction (e.g., the direction of longitudinal axis 208, where the longitudinal axis is orthogonal to the lateral axis). The body has a cross-sectional contour (e.g., a section taken along the lateral axis) that is defined by the die through which the mixture of glass fiber and resin is pultruded. The direction of pultrusion may be indicated by arrow 410 (shown by FIG. 4). The thickness of the body at various locations is described in additional detail below with reference to FIG. 7.

The hatch cover is shown having a first hinge 204 and a second hinge 206. In some embodiments, the first hinge and the second hinge may be coupled to the body via fasteners (e.g., first hinge may be coupled to the body via fasteners 205, and second hinge may be coupled to the body via fasteners 207). In other embodiments, the first hinge and second hinge may be coupled to the body via adhesives, clamps, and the like. The first hinge and second hinge may engage with a pin (e.g., journal) fixed to the vehicle and the hatch cover may pivot relative to the vehicle via the hinges (e.g., in order to adjust the hatch cover from the closed position to an opened position to provide access to the interior of the vehicle, or vice versa to seal access to the vehicle).

The hatch cover includes a first endcap 210 coupled to the body at a first end 220 of the body and a second endcap 214 coupled at an opposing, second end 222 of the body. The first endcap may reinforce the first end of the body and the second endcap may reinforce the second end of the body. In some embodiments, the first endcap and/or second endcap may be formed from a metal selected based on application specific parameters. Suitable metals may include steel and aluminum. The first endcap and the second endcap may be coupled to the body via fasteners, adhesives, etc. For example, first endcap may be coupled to the body via fasteners 230 and second endcap may be coupled to the body via fasteners 232. Suitable fasteners may include bolts, rivets, and the like. The first endcap and second endcap may be similar to, or the same as, the first endcap and the second endcap, respectively, described above with reference to FIG. 1.

The hatch cover may include a first gasket 216 and a second gasket 218. The first gasket and second gasket may extend along an entire length of the body in the longitudinal direction (e.g., the direction of longitudinal axis) and may seal against surfaces of the vehicle during conditions in which the hatch cover is coupled to the vehicle and is in a closed position (e.g., a position in which the hatch cover seals the opening of the vehicle). In some embodiments, the first gasket and the second gasket may be coupled directly to the body (e.g., via fasteners, adhesives, etc.). In other embodiments, the first gasket and the second gasket may be maintained in direct face-sharing contact with the body by the first endcap and the second endcap. For example, each gasket may include a surface (e.g., protrusion) shaped to engage with counterpart surfaces (e.g., grooves) of the first endcap and second endcap such that during conditions in which the gaskets are arranged against the body and the endcaps are coupled to the body, the coupling of the endcaps secures the gaskets to the body. Each gasket engages directly in face-sharing contact with the body, forming an interface 209 with the body. The interface may be sealed by the direct, face-sharing contact between the gaskets and the body such that fluid (e.g., air, water, etc.) does not pass through the interface. In some embodiments, a portion of each gasket may be arranged between the first endcap and the body to secure the gaskets to the first end of the body, and a portion of each gasket may be arranged between the second endcap and the body to secure the gaskets to the second end of the body. By designing the hatch cover with the gaskets, the hatch cover may reduce a likelihood of transfer of fluid (e.g., air, water, etc.) between the interior of the vehicle and the exterior of the vehicle (e.g., atmosphere).

Each of the first endcap and the second endcap may be sealed against the body such that fluid (e.g., air, water, etc.) does not pass between an interface formed between each endcap and the body. In some embodiments, the hatch cover may include a gasket rubber material at the interface between each endcap and the body in order to increase the sealing of the endcaps against the body.

In some embodiments, the hatch cover may include additional components such as a boxed frame, one or more bumpers, one or more support straps, etc. Such components may be coupled directly to the body via fasteners and/or adhesives, in some examples.

During conditions in which the hatch cover is coupled to the vehicle, the hatch cover may seal an opening of the vehicle so that a distance between the wheels of the vehicle (e.g., the wheels of the vehicle shown by FIG. 1 and described above) and an upper end 292 of the hatch cover may be greater than a distance between the wheels and a lower end 294 of the hatch cover.

Reference axes 299 are included in the FIGS. 2-7 for comparison of the views shown. The reference axes indicate a y-axis, an x-axis, and a z-axis. In one example, the z-axis may be parallel with a direction of gravity and the x-y plane may be parallel with a horizontal plane that the hatch cover may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

In the embodiment shown, the body includes a first leg 250 arranged at first side 201 and a second leg 350 (shown by FIG. 3) arranged at second side 203. The first leg and the second leg may increase a section modulus of the cross-sectional contour of the body, in some examples. In other embodiments, the body may not include a leg.

Referring to FIG. 4, a sectional view of the hatch cover is shown along the longitudinal axis. The direction of pultrusion of the body of the hatch cover may be parallel to the longitudinal axis. An enlarged view of a portion 400 of the body is shown by inset 402. The enlarged view illustrates an approximately constant thickness 404 of the body along an entire length of the body in the longitudinal direction (e.g., the direction of the longitudinal axis) at the central location of the body (e.g., the location of the longitudinal axis, where the longitudinal axis is centered to the lateral axis). The approximately constant thickness is provided via the pultrusion of the glass fiber material and resin through the die, as described above. Relative to conventional hatch covers which may have undesired variations in the thickness along the longitudinal length, the hatch cover of the present disclosure has an approximately constant and controlled thickness along the longitudinal length as depicted by FIG. 4.

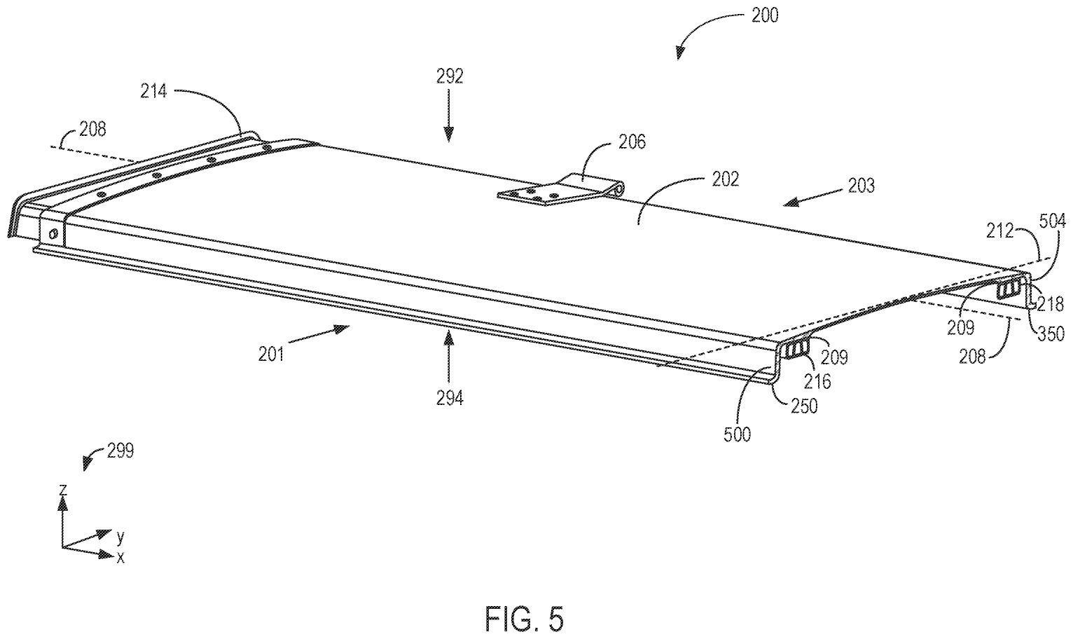

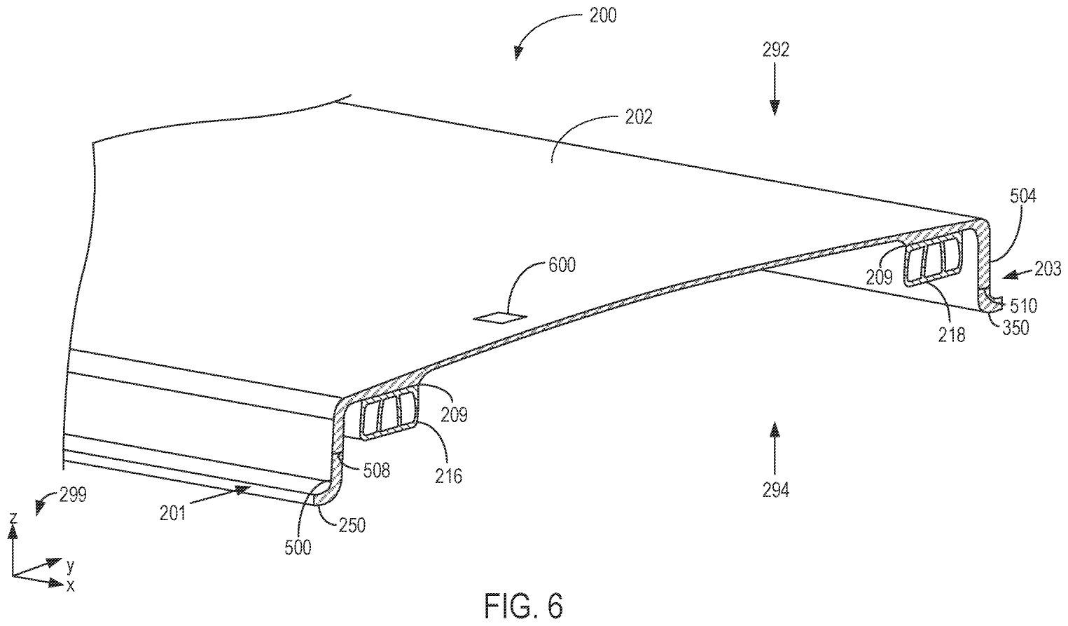

Referring collectively to FIGS. 5-6, sectional views of the hatch cover along the lateral axis are shown. In particular, FIG. 5 shows a perspective sectional view of the hatch cover taken along the lateral axis, and FIG. 6 shows an enlarged sectional view of the hatch cover at the location of the lateral axis (e.g., where the lateral axis is centered to the longitudinal axis).

The body of the hatch cover includes a first side extension 500 arranged at the first side and a second side extension 504 arranged at the second side. The first side extension is arranged opposite to the second side extension across the longitudinal axis. Each of the first side extension and the second side extension extends in a downward vertical direction perpendicular to each of the longitudinal axis and the lateral axis. In particular, during conditions in which the hatch cover is coupled to the vehicle, the first side extension and the second side extension each extend in the direction of the wheels of the vehicle. The first side extension has a thickness 508 in the lateral direction (e.g., the thickness extends in the direction of lateral axis), and the second side extension has a thickness 510 in the lateral direction. In the embodiment shown, the thicknesses are equal. However, in some embodiments, the thicknesses may differ.

The first side extension and the second side extension may be directly in face-sharing contact with surfaces of the vehicle during conditions in which the hatch cover is coupled to the vehicle. For example, the hatch cover may be supported in direct contact with the surface of the vehicle by the first side extension and the second side extension.

As described above, the hatch cover includes the first leg and the second leg in the embodiment shown. The first leg extends outward from the first side extension in a direction away from the longitudinal axis (e.g., away from the central portion of the hatch cover and away from the second side), and the second leg extends outward from the second side extension in an opposing direction away from the longitudinal axis (e.g., away from the first side). The first leg may extend outward perpendicular relative to the first side extension, and the second leg may extend outward perpendicular relative to the second side extension. In some embodiments, the first leg and the second leg may be parallel to each other. The first leg and the second leg increase the section modulus of the cross-section of the body.

Due to the level of control of the profile of the body provided using pultrusion, the thickness may be approximately constant along an entire longitudinal length of the body at the location of the first side extension, and the thickness is approximately constant along an entire longitudinal length of the body at the location of the second side extension. Because the thickness of the first side extension and the second side extension can be controlled more precisely along the entire longitudinal length of the body by forming the body via pultrusion as described above, the load bearing characteristics of the first side extension and second side extension may be increased relative to conventional hatch covers, and a durability of the hatch cover may be increased. Further, as the shape and contour of each side extension may be more accurately controlled via the pultrusion process (e.g., pultruding the glass fiber material and resin material through the die), a fitting of the hatch cover to the vehicle may be increased which may increase an ease of assembly of the hatch cover to the vehicle and/or reduce a likelihood of wear due to rubbing between the hatch cover and vehicle (or other degradation).

Referring to FIG. 7, an end view of the body is shown, with the body decoupled from the endcaps, hinges, etc. In particular, FIG. 7 shows a view of the first end of the body (with the first end additionally shown by FIGS. 1-2) with the body removed from the hatch cover. The body is shown having various thicknesses at different locations of the body in the lateral direction (e.g., the direction of the lateral axis). The body includes a thinner central section 700, where the lateral location of the thinner central section is indicated by a central plane 702. The central plane is parallel to the x-z plane of the reference axes (e.g., central plane extends in the longitudinal direction along the longitudinal axis, shown by FIGS. 2-5). Because the body is formed via pultrusion with the pultrusion direction being parallel with the x-axis of the reference axes, the thickness at the thinner central section is approximately equal along the entire longitudinal length of the body. The thinner central section joins to a first thicker section 704 in the direction of the first side and a second thicker section 706 in the direction of the second side (e.g., the thinner central section is between the first thicker section and the second thicker section). The lateral location of the first thicker section is indicated by the first plane 708, and the lateral location of the second thicker section is indicated by the second plane 710, where the first plane and the second plane are each parallel to the central plane. The thickness of the first thicker section (the thickness in the z-direction of the reference axes) is approximately constant along the entire longitudinal length of the body. Similarly, the thickness of the second thicker section is approximately constant along the entire longitudinal length of the body. In some embodiments, the first thicker section and the second thicker section may have a same thickness and contour.

The first thicker section joins to a first transition section 712 in the direction toward the first side, and the second thicker section joins to a second transition section 714 in the direction toward the second side. The lateral location of the first transition section is indicated by plane 716, and the lateral location of the second transition section is indicated by plane 718, where the planes are parallel to each other. The thickness of the first transition section (the thickness in the z-direction of the reference axes) is approximately constant along the entire longitudinal length of the body, and the thickness of the second transition section is approximately constant along the entire longitudinal length of the body. In the embodiment shown, the first transition section has a same thickness and contour as the second transition section. In other embodiments, however, the thickness and/or contour of the first transition section may be different relative to the second transition section.

The first transition section joins to a first side section 720 in the direction toward the first side, and the second transition section joins to a second side section 722 in the direction toward the second side. The first transition section tapers (e.g., reduces in thickness) from the first thicker section to the first side section, and the second transition section tapers from the second thicker section to the second side section. The lateral location of the first side section is indicated by a first side plane 724, and the lateral location of the second side section is indicated by a second side plane 726. These planes are all parallel to the central plane, the first plane, the second plane. The thickness of the first side section (the thickness in the z-direction of the reference axes) is approximately constant along the entire longitudinal length of the body, and the thickness of the second side section is approximately constant along the entire longitudinal length of the body. In the embodiment shown, the first side section has a same thickness and contour as the second side section. In other embodiments, however, the thickness and/or contour of the first side section may be different relative to the second side section.

The first side section curves to the first side extension via a first curved surface 730 with a radius of curvature 732. The second side section curves to the second side extension via a second curved surface 734 with a radius of curvature 736. In the embodiment shown, the radii of curvatures are approximately equal (e.g., a same amount of curvature). However, in other examples, the radii of curvatures may be different. The curvature radii may be selected with reference to end use parameters.

The body may curve such that during conditions in which the hatch cover is coupled to the vehicle, a distance between the thinner central section and the wheels of the vehicle in the vertical direction is larger than a distance between the wheels and other portions of the body in the vertical direction. For example, FIG. 7 shows axis 750 arranged parallel with the lateral axis, where the lateral axis intersects the thinner central section and the parallel axis intersects the first curved surface and the second curved surface. The lateral axis is offset from the parallel axis in the vertical direction away from the first side extension and the second side extension. The first side section, first transition section, and the first thicker section each curve (e.g., arc) toward the thinner central section in the direction away from the first side extension. The second side section, second transition section, and the second thicker section each curve toward the thinner central section in the direction away from the second side extension. The curving of the body in this configuration may additionally increase the strength (e.g., rigidity) of the body and may increase the durability of the body. The first transition section, the first thicker section, the thinner central section, the second thicker section, and the second transition section are a curved central portion of the body.

Inset 760 shows a front view of an example die 762 that may be used in the pultrusion of the body. The die defines an opening 764 that defines the shape and thickness of the body as the body is formed via pultrusion. By forming the various portions of the body via pultrusion, the body may provide desired strength characteristics with reduced material usage. For example, configuring the body such that the thickness of the first thicker section is greater than the thickness of each of the thinner central section and the thickness of the first transition section may provide a desired resistance of the body to twisting forces while also providing reduced material usage at the thinner central section and first transition section. As a result, the durability of the body may be increased. As another example, by forming the body via pultrusion, the radii of curvatures may be more precisely controlled. Precise control may result in a determined strength characteristic of the body having a relatively reduced amount of material usage.

Referring to FIG. 9, an enlarged view of a portion 900 of the body of the hatch cover is shown. The location of the enlarged view portion is indicated by the boundary 600 shown by FIG. 6. As described above, the body of the hatch cover may be formed by pultrusion, including the portion. The body includes the mixture of resin material and glass fiber material as described above, with a glass fiber material 902 and a resin material 904 shown by FIG. 9. The resin material and glass fiber material are mixed and pultruded through the die as described above in order to form the body. Due to the pultrusion process, the glass fiber material may be relatively more evenly distributed throughout the resin material and a larger amount of glass fiber material by weight is included throughout the body relative to conventional hatch covers.

The pultrusion process may include providing the glass fiber material and the resin material separately to a pultrusion device, and combining the glass fiber material and the resin material via the pultrusion device. For example, glass fiber material may be provided at an inlet of the pultrusion device, and the glass fiber material may be pulled through the pultrusion device. As the glass fiber is pulled through the pultrusion device, the glass fiber may be impregnated by the resin material to form a mixture of the glass fiber material and the resin material. As one example, the glass fiber may be pulled through a bath of the pultrusion device containing liquefied resin material, with the liquefied resin material penetrating and coating the strands of the glass fiber material. As another example, the glass fiber material may be pulled through a passage of the pultrusion device, with the passage including a resin source (e.g., an injector) configured to mix the resin material with the glass fiber material as the glass fiber material moves through the passage. The resin material may be provided within the passage in a liquefied state or may be heated to a liquefied state within the passage and combined with the glass fiber material within the passage. In some examples, the glass fiber material may consist of only glass fibers and may include no other materials, and the resin material may consist of only resin and may contain no other materials (e.g., the resin material may include no glass fiber material, with the mixture formed via the pultrusion device being a mixture of the pure glass fiber material provided at the inlet and the pure resin material provided via the bath and/or resin source within the passage). Following impregnation of the glass fiber material by the resin material via the pultrusion device to form the mixture of glass fiber material and resin material, the mixture may be pultruded through a die coupled to the pultrusion device to form the hatch cover body as a single, unitary uncured piece. The body may then be cured (e.g., via heat, ultraviolet radiation, etc.) to form the vehicle hatch cover.

By forming the hatch cover body via pultrusion as described above, the glass content by weight of the hatch cover body may be greater than 50%, which may not otherwise be achievable through a hand-laying process. Further, the glass fiber material may be oriented relative to the direction of pultrusion via the pultrusion process, which may further increase a strength of the hatch cover body relative to manufacturing processes that do not result in a pre-determined (e.g., selected) orientation of the glass fiber material. For example, the pultrusion process may provide for selection of the orientation of the glass fiber material to increase a strength of the hatch cover body in particular directions and/or for particular types of load that may be applied to the hatch cover body during operation of the vehicle. As one example, the orientation of the glass fiber material may be selected via the pultrusion process (e.g., via selection of the die profile) in order to increase a vertical compression strength of the hatch cover (where “vertical” refers to a direction of gravity during conditions in which the hatch cover is coupled to a vehicle, similar to the example shown by FIG. 1 and described above). As another example, the orientation of the glass fiber may be configured via the pultrusion process to increase a tensile strength of the hatch cover between opposing ends of the hatch cover. Other examples are possible.

By forming the hatch cover body via the pultrusion process, the resin material and the glass fiber material are not mixed by hand or by a mixer (e.g., mixing device). Instead, glass fiber is impregnated with resin via the resin bath or via injection of resin into the passage of the pultrusion device. Because the glass fiber material is impregnated with the resin material in the pultrusion process without churning, swirling, or other agitation of the glass fiber material, an integrity (e.g., durability) of individual fibers of the glass fiber material may be increased. Additionally, the orientation of the individual strands of the glass fiber material may be more easily controlled, which may further increase a strength of the hatch cover body as described above.

Further, because the glass fiber material and the resin are maintained separately until being combined via the pultrusion process, the percentage of glass fiber material by weight of the hatch cover body may be more easily and quickly adjusted during manufacturing. For example, an operator of the pultrusion device may form a first hatch cover body including a glass content by weight of 55% by feeding the glass fiber material to the inlet of the pultrusion device at a first rate. The operator may then desire to form a second hatch cover body including a glass content by weight of 65%. In order to provide the increased glass content, the operator may adjust the rate of feed of the glass fiber material into the inlet, in some examples without changing the type of glass fiber material or resin. As a result, a variety of different hatch cover bodies including different glass content by weight may be manufactured via the pultrusion process without changing the source material (e.g., without changing the glass fiber or the resin). Further, because the resin material and the glass fiber material are provided separately to the pultrusion device, the operator may more easily adjust the type of glass fiber material and/or the type of resin material included in the pultruded hatch cover body, if desired, and/or adjust parameters of the materials individually (e.g., exclusive from each other) such as glass fiber tension, resin flow rate, resin temperature versus glass fiber temperature, glass fiber spacing, resin viscosity, etc. As a result, a complexity of manufacturing multiple hatch cover bodies having different compositional properties may be greatly reduced while the strength of the hatch cover bodies may be increased via the pultrusion process as described above. Further, the desired properties of the hatch cover bodies may be provided with increased precision, which may result in increased consistency of the manufacturing process and reduced cost. Liquification of the resin material separately from the glass fiber material may also be accomplished with a reduced amount of energy (e.g., reduced application of heat) relative to liquification of a composite material including resin and at least one other material (e.g., a pre-mixed composite of resin material and glass fiber material), which may reduce a time and/or cost of the manufacturing of the hatch cover body and may increase a consistency of the strength of the hatch body cover (e.g., via increased uniformity of the distribution of glass fiber material throughout the hatch body cover resulting from increased operator control of the feed of glass fiber material to the inlet of the pultrusion device).

Referring to FIG. 10, a flowchart illustrating a method 1000 for manufacturing a fiberglass component of a vehicle via pultrusion is shown. The fiberglass component may be the hatch cover described above, in some embodiments. The vehicle may be similar to, or the same as, the vehicle system described above with reference to FIG. 1. In some embodiments the fiberglass component may be a different component of the vehicle (e.g., a casing, a deflector, a heat exchanger insulator, etc.).

Step 1002 includes providing a glass fiber material and a resin material to a die. The glass fiber material and the resin material. The method continues from step 1002 to step 1004 where a body of component of a vehicle is formed as a single, unitary piece with greater than 50% glass content via pultrusion of a mixture of the glass fiber material and resin material through the die.

The method continues from step 1004 to step 1006 includes curing the body and assembling the component. The assembling may include adding to the component features such as gaskets and/or endcaps that are coupled (e.g., joined) to the pultruded body. Curing the body may include increasing a temperature of the body to a temperature suitable for curing (e.g., hardening) the resin material (e.g., 50-100 degrees Celsius). The body may be fully cured prior to coupling of the gaskets, endcaps, etc. to the body. In each embodiment, the body is formed as a continuous, single, unitary piece via a single, continuous pultrusion without addition of fasteners or other components and may be modified thereafter (e.g., after the body has been formed via pultrusion) by the addition of the gaskets, endcaps, etc.

Assembling the component at step 1006 may include, at step 1008, positioning gaskets in face-sharing contact against the body of the component. For example, a first gasket and a second gasket may be positioned in face-sharing contact against the body at opposing sides of the body.

Assembling the component at step 1006 may include, at step 1010, securing the gaskets to the body of the component and reinforcing the body of the component by coupling a first endcap to a first end of the body in engagement with a first gasket and coupling a second endcap to an opposing, second end of the body in engagement with a second gasket. Coupling may be done via fasteners, adhesives, etc. The first gasket and the second gasket may be maintained in direct face-sharing contact with the body by the first endcap and the second endcap. For example, each gasket may include a surface (e.g., protrusion) shaped to engage with counterpart surfaces (e.g., grooves) of the first endcap and second endcap such that during conditions in which the gaskets are arranged against the body and the endcaps are coupled to the body, the coupling of the endcaps secures the gaskets to the body. In some examples, a portion of each gasket may be arranged between the first endcap and the body to secure the gaskets to the first end of the body, and a portion of each gasket may be arranged between the second endcap and the body to secure the gaskets to the second end of the body. In this configuration, the position of the gaskets relative to the body (e.g., the position of the first gasket against the body at the first side of the body and the position of the second gasket against the body at the opposing, second side of the body) may be maintained by the endcaps and without additional fasteners, adhesives, etc., which may reduce a cost of the component.

By forming the body of the component (e.g., body) via pultrusion as described above, the body is configured with greater than 50% glass content by weight and the glass fiber material may be more evenly distributed throughout the resin material. Further, the pultrusion process may provide increased control of the thickness, contour, curvature, etc. of the body such that the body may be formed with increased strength, increased insulation characteristics, and decreased cost. A technical effect of forming the body via pultrusion may provide the body with increased glass content and increased durability.

### EXAMPLES

Example 1: In a first example, two pultruded sample sheets of glass fiber reinforced polyester resin filled composite are produced, identical except for their fiber content by weight (P1 and P2); and two hand impregnated sample sheets of glass fiber reinforced polyester resin filled composite are produced, identical except for their fiber content by weight (H1 and H2). The glass content of H1 and P1 is 45% by weight of E-glass, which is alumino-borosilicate glass with less than 1% w/w alkali oxides. The glass content of H2 and P2 is 65% by weight of the same glass fiber. The fiber is multi-directionally oriented strands in a non-woven configuration. The determined directions of the oriented strands of P1 and P2 may be relative to the direction of pultrusion. No sizing is present on the fibers.

For samples P1 and P2 the pultrusion process uses a liquid resin bath and a pultrusion machine with a medium pressure setting. Care should be taken to avoid overheating and/or over catalyzation. The thickness of the sheets is set at one centimeter precisely. For samples H1 and H2 the hand layup process involves pouring resin over the fiber mats, and working the resin into the fibers using hand rollers. The final samples of H1 and H2 should be measured to approximate as close to one centimeter as possible.

After curing all four sample, H1, P1 and P2 are fully saturated with resin with no observable voids or delamination. H2 exhibits “dry glass” randomly distributed throughout with fiber “bloom” at the surface. Upon testing of the characteristics and properties of the samples, the result is P2 has significantly more tensile strength, bend resistance, impact resistance, and load strength at ambient and elevated temperatures than the H1, H2 and P1 samples. Examination of each sample shows a significant difference in the uniformity of thickness between the H1, H2 samples and the P1, P2 samples, with the P samples each being more uniform than the H samples.

### Example 2

Two pultruded sample sheets of glass fiber reinforced polyester resin filled composite are produced, identical except for their fiber content by weight (P5 and P6); and two hand impregnated sample sheets of glass fiber reinforced polyester resin filled composite are produced, identical except for their fiber content by weight (H5 and H6). The glass content of H5 and P5 is about 35% by weight of A-glass, which is alkali glass. The glass content of H6 and P6 is 75% by weight of the same glass fiber. The fiber is oriented strands in a woven configuration. Sizing is present on the fibers.

For samples P5 and P6 the pultrusion process uses a liquid resin bath and a pultrusion machine with a pressure setting that is higher than the pressure setting of EXAMPLE 1. Care should be taken to avoid overheating and/or over catalyzation. The thickness of the sheets is set at about two centimeters. For samples H5 and H6 the hand layup process involves pouring resin over the woven fiber mats and working the resin into the fibers using hand rollers. The final samples of H5 and H6 should be measured to be approximately as close to two centimeters as possible.

After curing all four samples, H5, P5 and P6 are fully saturated with resin with no observable voids or delamination. H6 strongly exhibits “dry glass” randomly distributed throughout with fiber “bloom” at the surface. Voids and air pockets are observable without assistance. H6 had more voids, dry areas, and bloom than H1, H5. Upon testing of the characteristics and properties of the samples, the result is that P6 has significantly more tensile strength, bend resistance, impact resistance, and load strength at ambient and elevated temperatures than the H5, H6 and P5 samples. The lower relative glass content for H5 and P5 compared to P6 results in less load bearing strength, especially at elevated temperatures. Examination of each sample shows a significant difference in the uniformity of thickness between the H5, H6 samples and the P5, P6 samples, with the P samples each being more uniform than the H samples. The P6 sample shows unexpectedly elevated levels of impact resistance, weather resistance, and strength, and maintains load bearing capabilities at high temperatures that are about the same as the P2 sample of EXAMPLE 1.

### Example 3

Two pultruded sample sheets of glass fiber reinforced polyester resin filled composite are produced, identical except for their fiber content by weight (P8 and P9); and two hand impregnated sample sheets of glass fiber reinforced polyester resin filled composite are produced, identical except for their fiber content by weight (H8 and H9). The glass content of H8 and P8 is about 25% by weight of A-glass. The glass content of H9 and P9 is 95% by weight of the same glass fiber. The fiber is oriented strands in a woven configuration. Sizing is present on the fibers.

For samples P8 and P9 the pultrusion process uses a liquid resin bath and a pultrusion machine with a pressure setting that is the same as the pressure setting of EXAMPLE 1. Care should be taken to avoid overheating and/or over catalyzation. The thickness of the sheets is set at about two centimeters. For samples H8 and H9 the hand layup process involves pouring resin over the woven fiber mats and working the resin into the fibers using hand rollers. The final samples of H8 and H9 should be measured to be approximately as close to two centimeters as possible.

After curing all four samples, H8, H9, P8 and P9, only samples H8, P8 are fully saturated with resin with no observable voids or delamination. P9 and H9 exhibit “dry glass” randomly distributed throughout with fiber “bloom” at the surface; voids and air pockets are observable without assistance. P9, H9 each had more voids, dry areas, and bloom than either of H8, P8. Upon testing of the characteristics and properties of the samples, the result is that both H8, P8 have significantly more tensile strength, bend resistance, impact resistance, and load strength at ambient and elevated temperatures than the H9 and P9 samples. None of the samples H8, P8, H9, P9 have, when compared to Example 1, better results for load bearing strength, regardless of test temperatures. Examination of each sample shows a significant difference in the uniformity of thickness between the H8, H9 samples compared to the P8, P9 samples, with the P samples each more uniform than the H samples (discounting fiber bloom for the H9, P9 samples). None of the samples show any elevated levels of impact resistance, weather resistance, and strength, nor do they maintain load bearing capabilities at high temperature.

Referring to FIG. 11, a graph 1100 including a plot 1106 illustrating a prophetic example of an average strength versus glass content relationship of a hatch cover for a rail vehicle is shown. The prophetic example relationship shown by FIG. 11 may apply to the hatch cover shown by FIGS. 2-7 and described above. Average strength as described herein and as shown by the vertical axis of the graph may refer to an average (e.g., mean) of various measures of strength, such as tensile strength, compressive strength, load bearing strength, resistance to creep, etc., for each section of the hatch cover. Average strength may further refer to bend resistance, impact resistance, etc. Glass content as described herein and as shown by the horizontal axis of the graph refers to the amount of glass content by weight of the hatch cover, where the glass content by weight is expressed as a percentage of the total weight of the body of the hatch cover. The body of the hatch cover may be formed via pultrusion, similar to the examples described above.

Sections of the hatch cover having a higher thickness may include a greater volume of glass content (e.g., axial strings) and resin material relative to sections of the hatch cover having a lower thickness. However, the percentage glass content by weight may be approximately uniform throughout the entirety of the body of the hatch cover, such that the ratio of glass material to resin material at thinner portions of the body may be approximately equal to the ratio of glass material to resin material at thicker portions of the body. Although the strength of the hatch cover may be increased at the sections having higher thickness, the relationship of average strength versus glass content by weight as depicted by the graph of FIG. 11 may apply to each section of the hatch cover. That is, the graph shown by FIG. 11 depicts the average strength for various different percentages of glass content by weight, and the relationship between the average strength and the percentage of glass content by weight is independent of material thickness. As one example, a first hatch cover body may be formed with 65% glass content by weight, and a second hatch cover body may be formed with 35% glass content by weight, with each of the first hatch cover body and the second hatch cover body being identically shaped. The first hatch cover and the second hatch cover may each include a thinner, first section, and a thicker, second section. The thicker section may have a larger strength (e.g., resistance to deformation, etc.) relative to the thinner section, due to increased material thickness. However, the thinner section of the first hatch cover may exhibit a larger average strength relative to the thinner section of the second hatch cover due to the increased glass content by weight of the first hatch cover. Similarly, the thicker section of the first hatch cover may exhibit a larger average strength relative to the thicker section of the second hatch cover due to the increased glass content by weight. While numerical measures of strength at the thicker and thinner sections of the first hatch may differ due to material thickness, a first ratio of the average strength at the thicker section of the first hatch to the average strength at the thicker section of the second hatch may be equal to a second ratio of the average strength at the thinner section of the first hatch to the average strength at the thinner section of the second hatch.

In the example shown, for hatch covers including 50% or less glass content by weight, the relationship between the percentage of glass content by weight versus average strength is approximately linear (e.g., the slope of the plot indicating the relationship between average strength and glass content by weight remains relatively constant for glass content percentages of 50% and lower). However, for percentages of glass content by weight greater than 50%, the relationship between average strength and the glass content may be non-linear (e.g., the slope of the plot indicating the relationship between average strength and glass content by weight varies for different percentages of glass content greater than 50%). In the graph shown by FIG. 11, vertical axis 1102 is arranged at the marker indicating 50% glass content by weight, and the horizontal axis 1108 is arranged perpendicular to the vertical axis and intersects the plot at the location of the vertical axis arranged at the 50% glass content marker.

In the example shown, for glass content percentages greater than 50% and less than approximately 90%, the average strength increases approximately parabolically, as indicated by the plot section 1120 shown in dotted lines. A linear projection 1110 is shown at the right-hand side of the graph (e.g., at the portion of the graph to the right-hand side of the vertical axis arranged at the 50% glass content marker) for the purpose of indicating the difference between the non-linear increase in average strength for glass content percentages greater than 50% relative to an approximately linear increase. The linear projection extends from the intersection of the horizontal axis and the vertical axis at the central portion of the graph, and the slope of the linear projection is equal to the approximately constant slope of the plot shown at left-hand side of the graph (e.g., the portion of the graph at which the plot indicates the relationship between average strength and glass content for glass content percentages of 50% or less). Although the plot of average strength versus glass content by weight is shown as having an approximately parabolic shape for glass content percentages greater than 50% in the example shown by FIG. 11, in other examples the average strength versus glass content by weight may have a different non-linear relationship for glass content percentages greater than 50%.

In the example shown, for glass content percentages greater than approximately 90%, the average strength decreases. The rate of decrease of average strength for glass content percentages greater than approximately 90% may be greater than the rate of increase of average strength for glass content percentages less than approximately 90%. As described above, the average strength may increase non-linearly (e.g., approximately parabolically) relative to glass content for glass content percentages greater than 50% and less than approximately 90%. As a result of the non-linear increase of average strength for glass content percentages greater than 50%, the average strength at approximately 90% glass content by weight may be higher than it would be if the average strength instead increased at a linear rate. Therefore, forming the hatch cover via pultrusion with greater than 50% glass content by weight may result in increased gains to average strength. For example, increasing the glass content percentage by a given amount (e.g., 1%) at glass content percentages greater than 50% may result in a larger increase to average strength relative to increasing the glass content percentage by the given amount at glass content percentages between 0% and 50%.

As one example, the vertical position of first marker 1112 indicates the average strength of a hatch cover including a glass content by weight of 75%, and the vertical position of second marker 1114 indicates the average strength of a hatch cover including a glass content by weight of 65%. The average strength indicated by the first marker is greater than the average strength indicated by the second marker. Further, the vertical position of third marker 1116 indicates the average strength of a hatch cover including a glass content by weight of 35%, and the vertical position of fourth marker 1118 indicates the average strength of a hatch cover including a glass content by weight of 25%. The average strength indicated by the third marker is greater than the average strength indicated by the fourth marker. However, the difference between the average strength indicated by the third marker and the average strength indicated by the fourth marker is less than the difference between the average strength indicated by the first marker and the average strength indicated by the second marker due to the non-linear relationship of average strength versus glass content for glass content by weight percentages greater than 50%. As a result, by forming the hatch cover via pultrusion, a glass content by weight greater than 50% may be achieved. The higher glass content may more efficiently increase the average strength, including strength such as average tensile strength and average high tensile modulus, of the hatch cover.

Switching to a general discussion of embodiments having aspects of the invention, a vehicle component may include a fiberglass-reinforced polymer body. The body may have a glass fabric and a cured polymer resin. The body may be integrally formed and have a glass content in a range that is greater than 50% by weight and less than about 95% by weight. In a first example of the vehicle component, the vehicle component is a vehicle hatch cover shaped to seal an opening of a vehicle. A second example of the vehicle component optionally includes the first example, and the body includes a first side extension and an opposing, second side extension, and a central section of the body curves away from each of the first side extension and the second side extension. A third example of the vehicle component optionally includes one or both of the first and second examples, and may include a first endcap coupled to the body at a first end of the body and a second endcap coupled to the body at an opposing, second end of the body. A fourth example of the vehicle component optionally includes one or more or each of the first through third examples, and further includes a gasket rubber material arranged at an interface between the body and both of first endcap and the second endcap, where the gasket rubber material seals the interface. A fifth example of the vehicle component optionally includes one or more or each of the first through fourth examples, and include each of a first gasket and a second gasket is engaged with the body by a first endcap at a first end of the body and a second endcap at an opposing, second end of the body. A sixth example of the vehicle component optionally includes one or more or each of the first through fifth examples, and further includes wherein the body includes a thinner central section joined to each of a first thicker section and a second thicker section, with the first thicker section tapering to a first side section via a first transition section and with the second thicker section tapering to an opposing, second side section via a second transition section. A seventh example of the vehicle component optionally includes one or more or each of the first through sixth examples, and further includes wherein the first side section joins to a first side extension via a first curved surface, and the second side section joins to a second side section via a second curved surface. An eighth example of the vehicle component optionally includes one or more or each of the first through seventh examples, and further includes wherein a radius of curvature of the first curved surface is equal to a radius of curvature of the second curved surface. A ninth example of the vehicle component optionally includes one or more or each of the first through eighth examples, and includes the body with a homogeneous mixture of the glass fabric and the cured polymer resin formed via pultrusion. A tenth example of the vehicle component optionally includes one or more or each of the first through ninth examples, and includes each portion of the body having a respective thickness in a direction between an upper end of the body and a lower end of the body, and the respective thickness of each portion of the body is approximately constant along a longitudinal direction of the body.

In another embodiment, a vehicle component includes a fiberglass-reinforced polymer body manufactured via a pultrusion process and including a curved central portion joined to a first side extension and an opposing, second side extension. In a first example of the vehicle component, the vehicle component has a first endcap coupled to the body at a first end of the body and a second endcap coupled to the body at an opposing, second end of the body. A second example of the vehicle component optionally includes the first example, and further includes wherein the vehicle component is a hatch cover and the fiberglass-reinforced polymer body consists of only a mixture of a resin material and a glass fiber material, with a weight of a total amount of the glass fiber material of the body being greater than a weight of a total amount of the resin material of the body. A third example of the vehicle component optionally includes one or both of the first and second examples, and further includes wherein the first side extension, the second side extension, and the curved central portion are formed together integrally via the pultrusion process, and wherein the curved central portion curves away from each of the first side extension and the second side extension.

In one embodiment, a method includes providing a glass fiber material and a resin material to a die; and forming a body of a component of a vehicle as a single, unitary piece with greater than 50% glass content via pultrusion of a mixture of the glass fiber material and the resin material through the die. In a first example of the method, the method includes assembling the component by coupling a first endcap to a first end of the body and coupling a second endcap to a second end of the body, where the first endcap opposes the second endcap in a direction of the pultrusion of the body. A second example of the method optionally includes the first example. The method may continue by assembling the component. Assembly includes engaging a first gasket directly in contact with the body at a first side of the body and engaging a second gasket directly in contact with the body at a second side of the body, where the first gasket and the second gasket extend along the body in the direction of the pultrusion of the body and the first side opposes the second side in a direction perpendicular to the direction of the pultrusion. A third example of the method optionally includes one or both of the first and second examples, and further includes: wherein forming the body includes forming a first side extension, a second side extension, and a curved central portion of the body together integrally via the pultrusion of the mixture through the die. A fourth example of the method optionally includes one or more or each of the first through third examples, and further includes: wherein forming the body includes maintaining a thickness of the body throughout the pultrusion of the mixture through the die, where the thickness is defined by an opening of the die.

In another embodiment, a component for a vehicle comprises: a pultruded fiberglass-reinforced polymer body comprising a glass fabric and a cured polymer resin, where the pultruded fiberglass-reinforced polymer body is integrally formed as a hatch cover that is shaped to seal an opening of the vehicle. In a first example of the system, the pultruded fiberglass-reinforced polymer body has a larger glass fabric content by weight than cured polymer resin content by weight. In a second example of the system, optionally including the first example, the pultruded fiberglass-reinforced polymer body includes a first side extension and an opposing, second side extension, and a central section of the pultruded fiberglass-reinforced polymer body curves away from each of the first side extension and the second side extension. In a third example of the system, optionally including one or both of the first and second examples, the system further comprises: a first endcap coupled to the pultruded fiberglass-reinforced polymer body at a first end of the pultruded fiberglass-reinforced polymer body and a second endcap coupled to the pultruded fiberglass-reinforced polymer body at an opposing, second end of the pultruded fiberglass-reinforced polymer body. In a fourth example of the system, optionally including one or more or each of the first through third examples, the system further comprises: a gasket rubber material arranged at an interface between the pultruded fiberglass-reinforced polymer body and both of the first endcap and the second endcap, where the gasket rubber material seals the interface. In a fifth example of the system, optionally including one or more or each of the first through fourth examples, each of a first gasket and a second gasket is engaged with the pultruded fiberglass-reinforced polymer body by the first endcap at the first end of the pultruded fiberglass-reinforced polymer body and the second endcap at the opposing, second end of the pultruded fiberglass-reinforced polymer body. In a sixth example of the system, optionally including one or more or each of the first through fifth examples, the pultruded fiberglass-reinforced polymer body includes a thinner central section joined to each of a first thicker section and a second thicker section, with the first thicker section tapering to a first side section via a first transition section and with the second thicker section tapering to an opposing, second side section via a second transition section. In a seventh example of the system, optionally including one or more or each of the first through sixth examples, the first side section joins to a first side extension via a first curved surface, and the second side section joins to a second side section via a second curved surface. In an eighth example of the system, optionally including one or more or each of the first through seventh examples, a radius of curvature of the first curved surface is about equal to a radius of curvature of the second curved surface. In a ninth example of the system, optionally including one or more or each of the first through eighth examples, the pultruded fiberglass-reinforced polymer body is a homogeneous mixture of the glass fabric and the cured polymer resin that is formed via pultrusion. In a tenth example of the system, optionally including one or more or each of the first through ninth examples, each portion of the pultruded fiberglass-reinforced polymer body has a respective thickness in a direction between an upper end of the pultruded fiberglass-reinforced polymer body and a lower end of the pultruded fiberglass-reinforced polymer body, and where the respective thickness of each portion of the pultruded fiberglass-reinforced polymer body is approximately constant along a longitudinal direction of the pultruded fiberglass-reinforced polymer body.

In another embodiment, a vehicle component comprises: a pultruded fiberglass-reinforced polymer body configured to form at least a portion of a hatch cover and that includes a curved central portion joined to a first side extension and an opposing, second side extension, where a glass material and a resin material of the pultruded fiberglass-reinforced polymer body are combined during pultrusion of the pultruded fiberglass-reinforced polymer body. In a first example of the system, the system further comprises: a first endcap coupled to the pultruded fiberglass-reinforced polymer body at a first end of the pultruded fiberglass-reinforced polymer body and a second endcap coupled to the pultruded fiberglass-reinforced polymer body at an opposing, second end of the pultruded fiberglass-reinforced polymer body. In a second example of the system, optionally including the first example, the pultruded fiberglass-reinforced polymer body consists of only a mixture of the resin material and the glass fiber material, with a weight of a total amount of the glass fiber material of the pultruded fiberglass-reinforced polymer body being greater than a weight of a total amount of the resin material of the pultruded fiberglass-reinforced polymer body, and the glass fiber material being an A-glass or C-glass that is directionally oriented in determined directions to form a multilayer woven configuration. In a third example of the system, optionally including one or both of the first and second examples, the first side extension, the second side extension, and the curved central portion are formed together integrally with the pultruded fiberglass-reinforced polymer body via a pultrusion process, and wherein the curved central portion curves away from each of the first side extension and the second side extension.

In another embodiment, a method comprises: providing a glass fiber material and a resin material separately to a pultrusion device, forming a mixture of the glass fiber material and the resin material by impregnating the glass fiber material with the resin material while the glass fiber material is pulled through the pultrusion device, pultruding the mixture of the glass fiber material and the resin material through a die coupled to the pultrusion device, wherein the glass fiber material is oriented relative to a direction of the pultrusion, to form a body as a single, unitary uncured piece, and curing the body to form a vehicle hatch cover. In a first example of the method, the method further comprises: assembling further the vehicle hatch cover by coupling a first endcap to a first end of the body and coupling a second endcap to a second end of the body, where the first endcap opposes the second endcap in the direction of the pultrusion of the body. In a second example of the method, optionally including the first example, assembling further the vehicle hatch cover further comprises engaging a first gasket directly in contact with the body at a first side of the body and engaging a second gasket directly in contact with the body at a second side of the body, where the first gasket and the second gasket extend along the body in the direction of the pultrusion of the body and the first side opposes the second side in a direction perpendicular to the direction of the pultrusion. In a third example of the method, optionally including one or both of the first and second examples, forming the body includes forming a first side extension, a second side extension, and a curved central portion of the body together integrally via the pultrusion of the mixture through the die. In a fourth example of the method, optionally including one or more or each of the first through third examples, forming the body includes maintaining a thickness of the body throughout the pultrusion of the mixture through the die.

Diagrams in the Figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another.

A topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Reference is made in detail to various embodiments of the inventive subject matter, examples of which are illustrated in the accompanying drawings. The same reference numerals used throughout the drawings may refer to the same or like parts. As disclosed below, multiple version of a same element may be disclosed. Likewise, with respect to other elements, a singular version may be is disclosed. Neither multiple versions disclosed nor a singular version disclosed shall be considered limiting. Specifically, although multiple versions are disclosed, a singular version may be utilized. Likewise, where a singular version is disclosed, multiple versions may be utilized. The description is illustrative and not restrictive. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Other embodiments may be apparent to one of ordinary skill in the art upon reviewing the above description.

As used herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, limitations are not written in means-plus-function format and are not intended to be interpreted based on 35 U.S.C. § 112(f), unless and until such limitations expressly use the phrase “means for” followed by a statement of function void of further structure. And, as used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

1. A component for a vehicle, comprising:
a pultruded fiberglass-reinforced polymer body comprising a glass fabric and a cured polymer resin, where the pultruded fiberglass-reinforced polymer body is integrally formed as a hatch cover that is shaped to seal an opening of the vehicle.

2. The component of claim 1, wherein the pultruded fiberglass-reinforced polymer body has a larger glass fabric content by weight than cured polymer resin content by weight.

3. The component of claim 1, wherein the pultruded fiberglass-reinforced polymer body includes a first side extension and an opposing, second side extension, and a central section of the pultruded fiberglass-reinforced polymer body curves away from each of the first side extension and the second side extension.

4. The component of claim 1, further comprising a first endcap coupled to the pultruded fiberglass-reinforced polymer body at a first end of the pultruded fiberglass-reinforced polymer body and a second endcap coupled to the pultruded fiberglass-reinforced polymer body at an opposing, second end of the pultruded fiberglass-reinforced polymer body.

5. The component of claim 4, further comprising a gasket rubber material arranged at an interface between the pultruded fiberglass-reinforced polymer body and both of the first endcap and the second endcap, where the gasket rubber material seals the interface.

6. The component of claim 4, wherein each of a first gasket and a second gasket is engaged with the pultruded fiberglass-reinforced polymer body by the first endcap at the first end of the pultruded fiberglass-reinforced polymer body and the second endcap at the opposing, second end of the pultruded fiberglass-reinforced polymer body.

7. The component of claim 1, wherein the pultruded fiberglass-reinforced polymer body includes a thinner central section joined to each of a first thicker section and a second thicker section, with the first thicker section tapering to a first side section via a first transition section and with the second thicker section tapering to an opposing, second side section via a second transition section.

8. The component of claim 7, wherein the first side section joins to a first side extension via a first curved surface, and the second side section joins to a second side section via a second curved surface.

9. The component of claim 8, wherein a radius of curvature of the first curved surface is about equal to a radius of curvature of the second curved surface.

10. The component of claim 1, wherein the pultruded fiberglass-reinforced polymer body is a homogeneous mixture of the glass fabric and the cured polymer resin that is formed via pultrusion.

11. The component of claim 1, wherein each portion of the pultruded fiberglass-reinforced polymer body has a respective thickness in a direction between an upper end of the pultruded fiberglass-reinforced polymer body and a lower end of the pultruded fiberglass-reinforced polymer body, and where the respective thickness of each portion of the pultruded fiberglass-reinforced polymer body is approximately constant along a longitudinal direction of the pultruded fiberglass-reinforced polymer body.

12. A vehicle component, comprising:
a pultruded fiberglass-reinforced polymer body configured to form at least a portion of a hatch cover and that includes a curved central portion joined to a first side extension and an opposing, second side extension, where a glass fiber material and a resin material of the pultruded fiberglass-reinforced polymer body are combined during pultrusion of the pultruded fiberglass-reinforced polymer body.

13. The vehicle component of claim 12, further comprising a first endcap coupled to the pultruded fiberglass-reinforced polymer body at a first end of the pultruded fiberglass-reinforced polymer body and a second endcap coupled to the pultruded fiberglass-reinforced polymer body at an opposing, second end of the pultruded fiberglass-reinforced polymer body.

14. The vehicle component of claim 12, wherein the pultruded fiberglass-reinforced polymer body consists of only a mixture of the resin material and the glass fiber material, with a weight of a total amount of the glass fiber material of the pultruded fiberglass-reinforced polymer body being greater than a weight of a total amount of the resin material of the pultruded fiberglass-reinforced polymer body, and the glass fiber material being an A-glass or C-glass that is directionally oriented in determined directions to form a multilayer woven configuration.

15. The vehicle component of claim 14, wherein the first side extension, the second side extension, and the curved central portion are formed together integrally with the pultruded fiberglass-reinforced polymer body via a pultrusion process, and wherein the curved central portion curves away from each of the first side extension and the second side extension.

16. A method, comprising:
providing a glass fiber material and a resin material separately to a pultrusion device;
forming a mixture of the glass fiber material and the resin material by impregnating the glass fiber material with the resin material while the glass fiber material is pulled through the pultrusion device;
pultruding the mixture of the glass fiber material and the resin material through a die coupled to the pultrusion device, wherein the glass fiber material is oriented relative to a direction of the pultrusion, to form a body as a single, unitary uncured piece; and
curing the body to form a vehicle hatch cover.

17. The method of claim 16, further comprising assembling further the vehicle hatch cover by coupling a first endcap to a first end of the body and coupling a second endcap to a second end of the body, where the first endcap opposes the second endcap in the direction of the pultrusion of the body.

18. The method of claim 17, wherein assembling further the vehicle hatch cover further comprises engaging a first gasket directly in contact with the body at a first side of the body and engaging a second gasket directly in contact with the body at a second side of the body, where the first gasket and the second gasket extend along the body in the direction of the pultrusion of the body and the first side opposes the second side in a direction perpendicular to the direction of the pultrusion.

19. The method of claim 16, wherein forming the body includes forming a first side extension, a second side extension, and a curved central portion of the body together integrally via the pultrusion of the mixture through the die.

20. The method of claim 19, wherein forming the body includes maintaining a thickness of the body throughout the pultrusion of the mixture through the die.
